(19) United States
(12) Patent Application Publication
(10) Pub. No.: US 2019/0172009 A1
(43) Pub. Date: Jun. 6, 2019

(54) Freight Logistics Systems and Methods

(71) Applicant: Vitali Iavorschii, Western Springs, IL (US)

(72) Inventor: Vitali Iavorschii, Western Springs, IL (US)

(21) Appl. No.: 16/207,928

(22) Filed: Dec. 3, 2018

Related U.S. Application Data
(60) Provisional application No. 62/595,406, filed on Dec. 6, 2017.

(51) Int. Cl. G06Q 10/08; G06F 16/9537; G06F 16/9538

(52) U.S. Cl. CPC G06Q 10/0835; G06F 16/9538; G06F 16/9537

(57) ABSTRACT

The present disclosure provides a system and method that receives load data from publicly available freight exchanges, enables users to post and search for loads and trucks, and automatically calls the parties listed in the search results. By calling on a number of available loads or trucks at a time, the freight logistics system increases a user's likelihood of obtaining a load or truck for shipment, the success of which is scalable when used by a freight broker or a shipper having a large amount of freight to be transported.

### CROSS-REFERENCE TO RELATED APPLICATIONS

This application incorporates by reference and claims the benefit of priority to U.S. Provisional Application 62/595,406 filed on Dec. 6, 2017.

### BACKGROUND OF THE INVENTION

The present subject matter relates generally to a freight logistics platform enabling shippers, carriers, freight brokers, and other parties to find freight and trucks. More specifically, the present invention relates to a freight logistics platform that enables parties to automatically call one or more contacts listed in a search result for available loads and trucks.

There are a number of active players involved with the shipment of freight within the freight logistics industry. Shippers are continually in need of carriers to move goods across various distances, and carriers are equally in need of finding loads to carry that align with their travel plans. Freight brokers track available loads in order to connect carriers and shippers.

To find a carrier, shippers and carriers typically post available loads and trucks, respectively, on on-demand freight exchanges referred to as load boards. Shippers advertise available loads by posting details about the loads, such as size and weight, origin, and destination. Carriers search the routes they are planning to take to find loads to transport. Carriers can also post their available trucks to allow brokers to contact them with shipment needs.

To get a load, carriers find available loads that meet their needs and call the contact information listed for that load. During peak times, loads are listed as available for only a matter of seconds before the shipper has secured a carrier. Depending on the limitations that a carrier has in terms of size requirements (if looking for a load to fill its container) and location, the loads available to him may be very limited, making the selection process very competitive.

A number of freight exchanges are available. Many shippers and carriers post to a number of boards, in order to increase competition. There is no centralized system for tracking shipment needs.

Accordingly, there is a need for freight logistics systems and methods that provide carriers and shippers with an optimal and efficient platform for connecting carriers to shippers, as described herein.

### BRIEF SUMMARY OF THE INVENTION

To meet the needs described above and others, the present disclosure provides freight logistics systems and methods that provide carriers and shippers with an optimal and efficient platform for connecting carriers, shippers, and other parties.

The present disclosure provides a system and method that receives load data from publicly available freight exchanges, enables users to post and search for loads and trucks, and automatically calls the parties listed in the search results. By calling on a number of available loads or trucks at a time, the freight logistics system increases a user's likelihood of obtaining a load or truck for shipment, the success of which is scalable when used by a freight broker or a shipper having a large amount of freight to be transported.

The details of illustrative aspects of the specification are set forth in the description and drawings below. These aspects are but a few of the ways in which the principles laid out in the specification may be employed in illustrative embodiments. Other advantages, features and objects will be apparent from the description, drawings and claims.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

An object of the invention is to provide a system for searching a large amount of freight data and calling a number of available loads and trucks within a short period of time to increase the chances of obtaining a load.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic representation of a freight logistics system, according to an example embodiment;

FIG. 2 is an embodiment of a user interface displaying the Create Post Load search box of the freight exchange system of FIG. 1;

FIG. 3 is an embodiment of a user interface displaying the multiple call feature of the freight exchange system of FIG. 1;

FIG. 4 is an embodiment of a user interface displaying the Create Post Truck search box of the freight exchange system of FIG. 1;

FIG. 5 is an embodiment of a user interface displaying the Create Search Load search box of the freight exchange system of FIG. 1;

FIG. 6 is an embodiment of a user interface displaying the Broker Dispatch of the freight exchange system of FIG. 1;

FIG. 7 is an embodiment of a user interface displaying the Carrier Dispatch of the freight exchange system of FIG. 1;

FIG. 8 is an embodiment of a user interface displaying the Broker Accounting of the freight exchange system of FIG. 1;

FIG. 9 is an embodiment of a user interface displaying the Carrier Accounting of the freight exchange system of FIG. 1;

FIG. 10 is an embodiment of a user interface displaying the tabs of the Settings box of the freight exchange system of FIG. 1;

FIG. 11 is an embodiment of a user interface displaying the Data Sources box of the freight exchange system of FIG. 1; and

FIG. 12 is an embodiment of a user interface displaying the Blacklist box of the freight exchange system of FIG. 1.

### DETAILED DESCRIPTION OF THE INVENTION

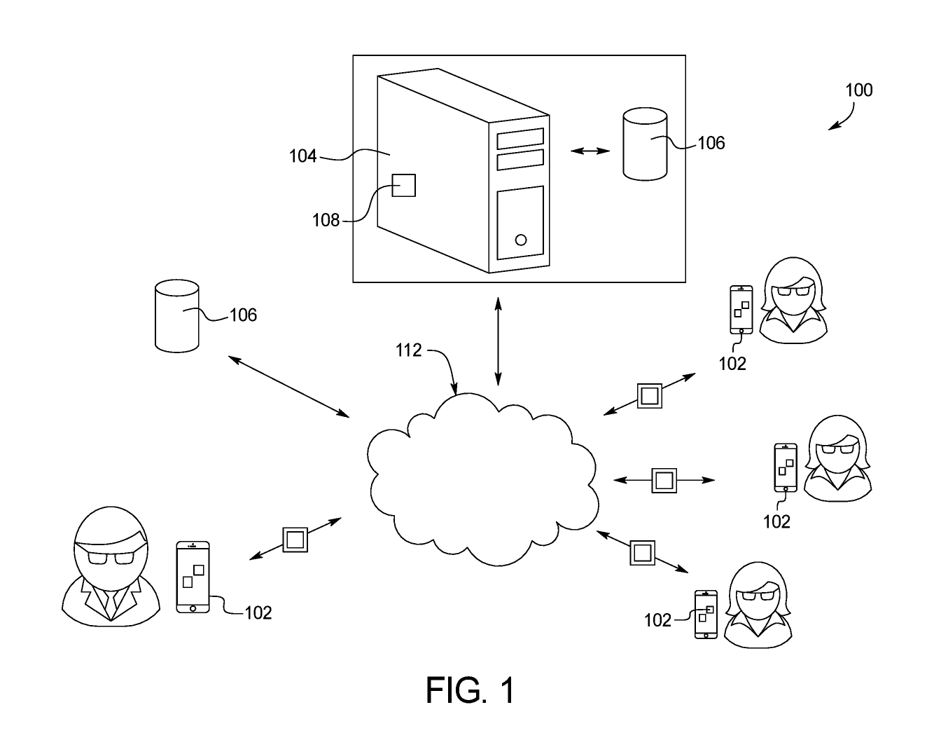

FIG. 1 illustrates an example freight logistics system 100 that enables parties to automatically call one or more contacts listed in a search result for available loads and trucks. The system includes a plurality of devices 102 such as computers, tablets, and mobile devices associated with a controller. The controller 104 is in communication with one or more databases 106 storing freight data and facilitates the sharing of information between the carriers, the shippers, the freight brokers, and other parties that access the system through one of the plurality of devices. Each device is equipped with a phone system that enables multiple calling such as Skype or Bria.

The system receives freight data from one or more freight exchanges, such as DAT and Truckstop, on a real-time basis. Freight data includes available loads and trucks, including details such as the origin and destination, the weight, the length, and the shipper name and contact information. The system catalogues the freight data for searching by the users.

All or part of the systems and methods described herein may be implemented in a computer system which includes a set of instructions stored on one or more non-transitory machine-readable storage media and/or memory 108 and executable on one or more processing devices. All or part of the systems and methods described herein may be implemented as an apparatus, method or system which may include one or more processing devices and memory which stores executable instructions to implement the example functions.

Once the user selects the Autocall function available in the user interfaces described below, the freight logistics system automatically calls the contact numbers of the search results. In some embodiments, the user selects the phone numbers to be called. In other embodiments, the freight logistics system automatically calls numbers of the search results starting with the first posting. The automatic calling allows users to call without any delay and allows users to call up to five phone numbers at a time.

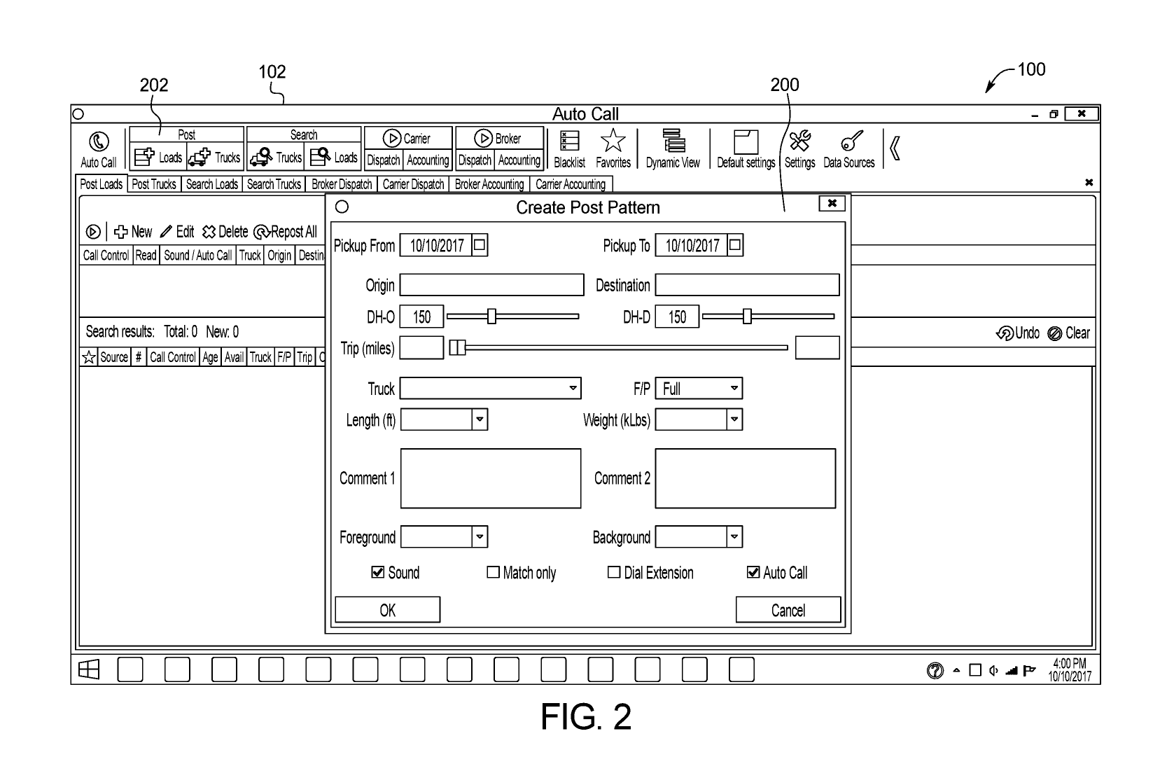

Shippers, carriers, freight brokers, and other parties may access and interact with elements of the freight logistics system through the user interfaces of FIGS. 2-12. A main page includes a plurality of buttons in a header of the page. Selection of the Post, Search, Carrier, and Broker buttons create corresponding tabs in the body of the page. In the main page illustrated in FIG. 2, the Post Load tab is displayed.

To post an available load in need of transportation, a shipper selects the New button within the Post Load tab, which leads to the Create Post Load search box 200 shown in FIG. 2. In the Create Post Load search box 200, the shipper enters the pick-up date, origin, the drop-off date, the destination, and the mileage. The shipper can also specify the truck type, the length and weight of the load, and whether the load is full or partial. The Create Post Load search box also includes fields for entering comments. The shipper can select the color of the foreground and background of the posting as it appears on the main page. The Create Post Load search box also includes optional features for sound and auto calling.

Selection of the OK button in the Create Post Load search box causes the load to be posted on the Post Loads tab 202. During an active session, the Post Loads tab 202 provides the post including the details entered into the Create Post Load search box 200. Each post can include details such as the freight exchange source, the age of the post, the truck type, the origin, the destination, the deadhead from origin, the deadhead from destination, the length and weight of the load, the shipper name, and shipper's phone number. In the illustrated embodiment, each searched post is provided in the upper box, and the results of each searched post are provided in the lower box, although other organization and presentation may be used as desired.

For example, in response to receiving a load request for shipping, the system can include receiving locomotive availability information associated with a carrier, wherein the locomotive availability information includes locomotive contact information, dates of availability, and a space amount of availability. The locomotive availability information can be stored in a database in communication with the controller. The system can include determining selected carriers to satisfy the load request from the database based on matching the load data for shipment with the received locomotive availability information associated with a carrier. In an example, the system can generate a likelihood of success for shipment of the load data by the date of delivery for each of the selected carriers. For example, the determination of the likelihood of success can be based on the degree of matching parameters. For example, carriers that are associated with availability that matches more of the shipper's load request parameters have a higher likelihood of success of completing the shipment on time. The likelihood of success can take into account the carrier and/or broker's past performance. For example, if the carrier has a 90% success rate of meeting is previous shipments on time, the carrier will have a higher likelihood of success than carriers with lower percentage of historical success rates. The likelihood of success can be based on any suitable parameters including, but not limited to, historical performance, amount of trucks available to the carrier and/or broker, proximity of the carrier to the pick-up location of the shipper, the response time of confirmation of the carrier to accept the load request, among others.

The system can select the locomotive contact information associated with each carrier associated with a likelihood of success greater than a predefined success value. For example, carriers can be selected if the system generated a likelihood of success of greater than 80%, 85%, or 90%, among others, for the selected carrier. The system can contact the selected locomotive contact information associated with the selected carriers having the likelihood of success above the predetermined value. The system can receive confirmation to ship the freight data by the requested delivery date from at least one contacted carrier. Once confirmation is achieved, the system can display the confirmed carrier information to a user interface associated with the shipper associated with the load data. The shipper can contact the selected carrier. The system can also automatically facilitate payment between the shipper and carrier and/or broker.

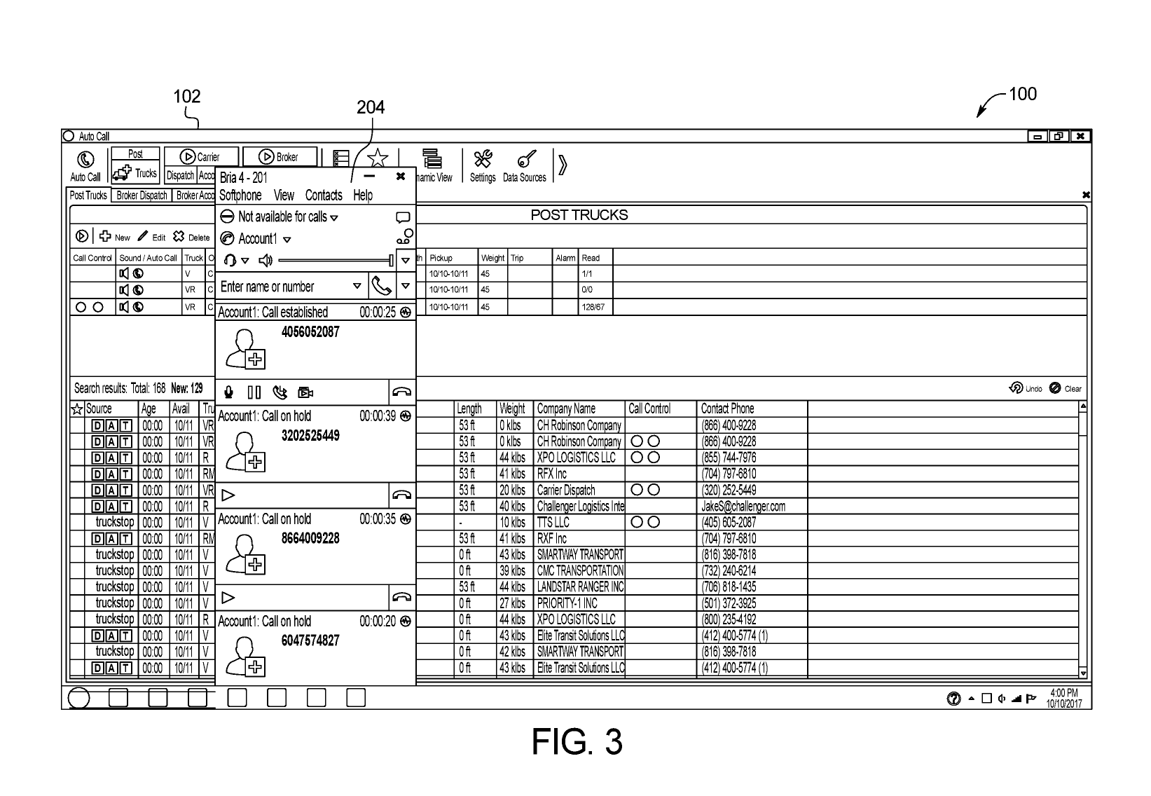

FIG. 3 illustrates the autocalling feature 204 of the freight logistics system. By selecting the Autocall button in the header of the main page, the freight logistics system launches the phone system and the user can select the phone number of a load in the search results to initiate a phone call. The freight logistics system can dial up to five numbers at one time. Once a person has answered the phone, that call is established and any other calls that are ringing at that time and answered are put on hold. If the established call is lost, the first call on hold is connected and established. Due to the high numbers of calls being made at any time, the process is quick and calls are being connected and established at a high rate. The user may select the red button on each call to terminate the call.

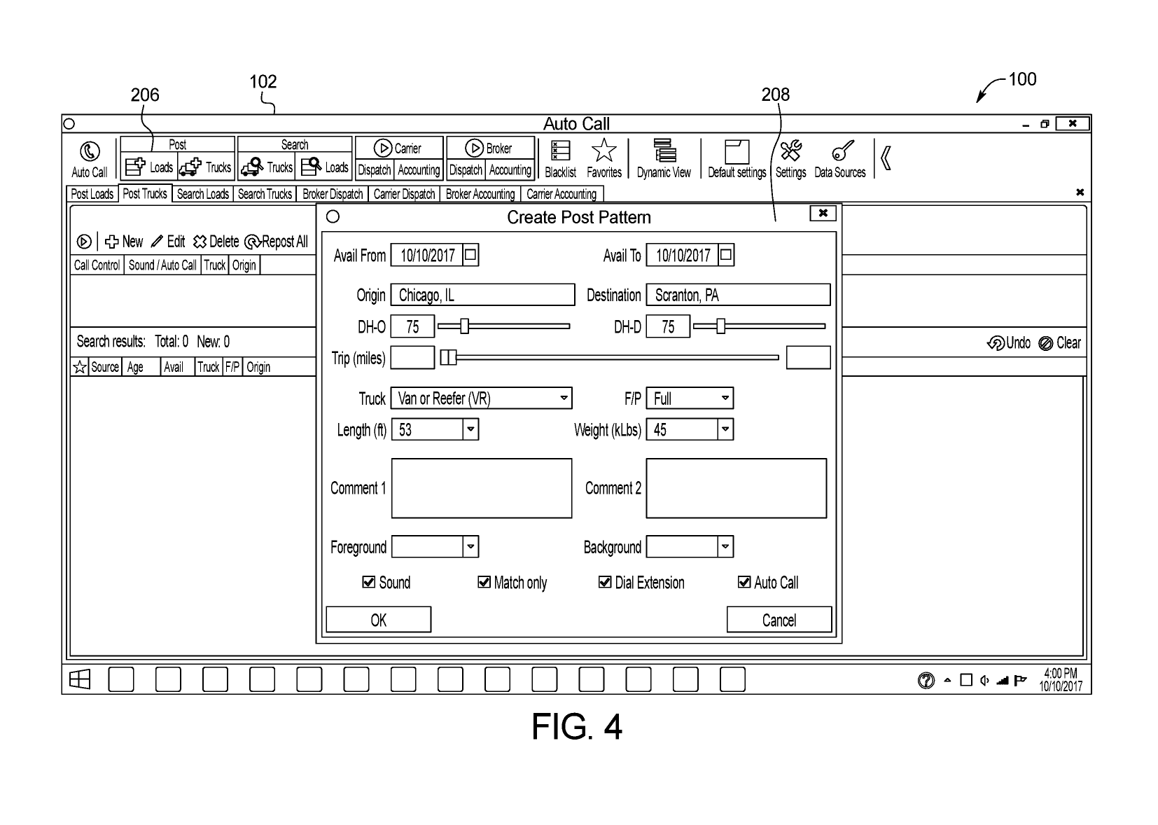

In order for a carrier to post truck availability, the carrier selects the New button on the Post Trucks tab 206 on the main page shown in FIG. 4, which leads to the Create Post Truck search box 208 of FIG. 4. In the Create Post Truck search box 208, the carrier enters the availability dates, the origin, the destination, the mileage, and the deadhead from origin and from destination. The carrier can also specify the truck type, the length and weight available, and whether the load is full or partial. The Create Post Truck search box 208 also includes fields for entering comments and color selection as it appears on the main page. The Create Post Load search box 208 also includes optional features for sound and auto calling.

Referring back to FIG. 4, the Post Trucks tab 206 provides the resulting posts that correspond to the parameters entered into the Create Post Truck search box 208. Each post includes details such as the freight exchange source, the age of the post, the availability date, the truck type, the origin, the mileage, the destination, the length and weight, and the carrier's name and phone number. In the illustrated embodiment, each searched post is provided in the upper box, and the results of each searched post are provided in the lower box. The user can select the Autocall button in the header to launch the phone call session as described above.

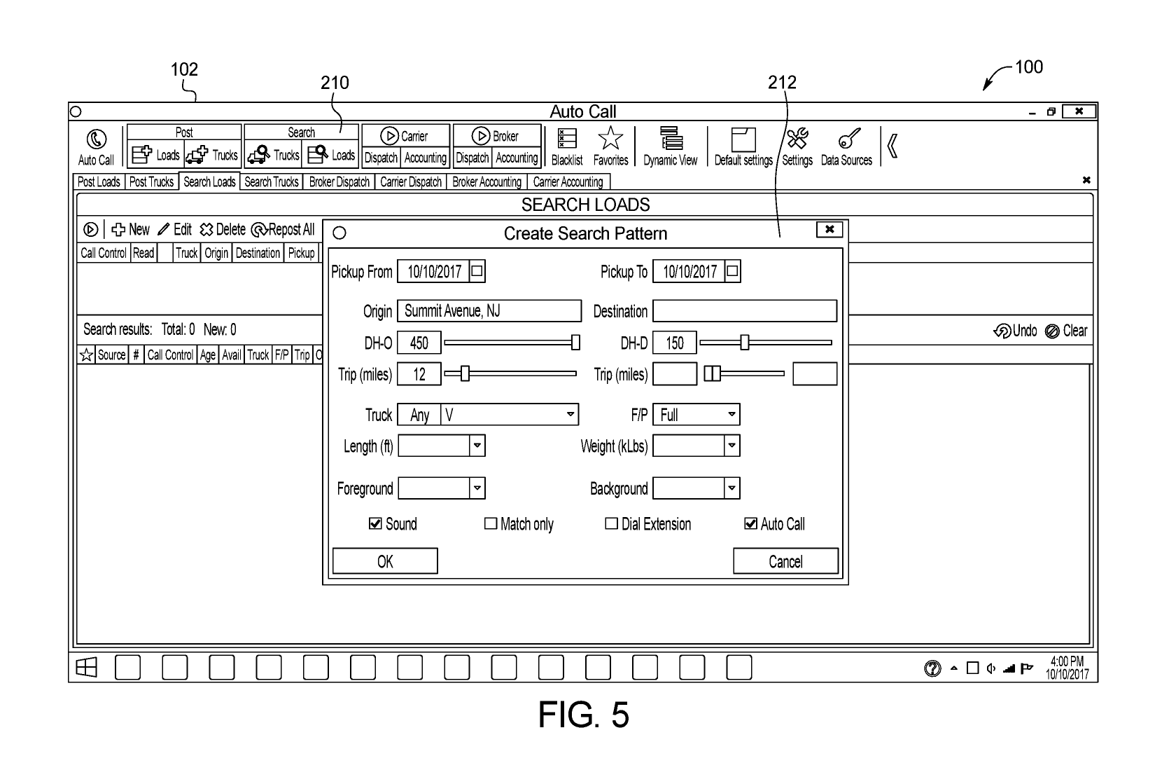

For a carrier to search for available loads, the carrier selects the Search Loads tab on the main page. Selecting the New button on the Search Loads tab 210 leads to the Create Search Load search box 212 shown in FIG. 5. The carrier enters details such as the pick-up and drop-off dates, the origin and destination, the truck type, and the length and weight of the load. By selecting the OK button in the Create Search Load search box 212, the freight logistics system performs a search of the freight data and lists the posts with details that fit the parameters of the respective search.

Each post can include details such as the freight exchange source, the age of the post, the availability date, the truck type, the origin, the mileage, the destination, the length and weight, and the carrier's name and phone number. Each searched post is provided in an upper box, and the results of each searched post are provided in the lower box. The user can select the Autocall button in the header to launch the phone call session as described above.

A shipper can use the freight logistics system to find available trucks to meet its shipping needs. The shipper selects the Search Trucks tab 210 on the main page. Selecting the New button on the Search Trucks tab leads to the Create Search Truck search box 212, shown in FIG. 5. The carrier enters details such as the pick-up and drop-off dates, the origin and destination, the truck type, and the length and weight of the load. By selecting the OK button in the Create Search Truck search box, the freight logistics system performs a search of the freight data and lists the posts with details that fit the parameters of the respective search.

The posts of the search results are listed in the Search Trucks tab 210. Each post includes details such as the freight exchange source, the age of the post, the availability date, the truck type, the origin, the mileage, the destination, the length and weight, and the carrier's name and phone number. Each searched post is provided in an upper box, and the results of each searched post are provided in the lower box. The user can select the Autocall button in the header to launch the phone call session as described above.

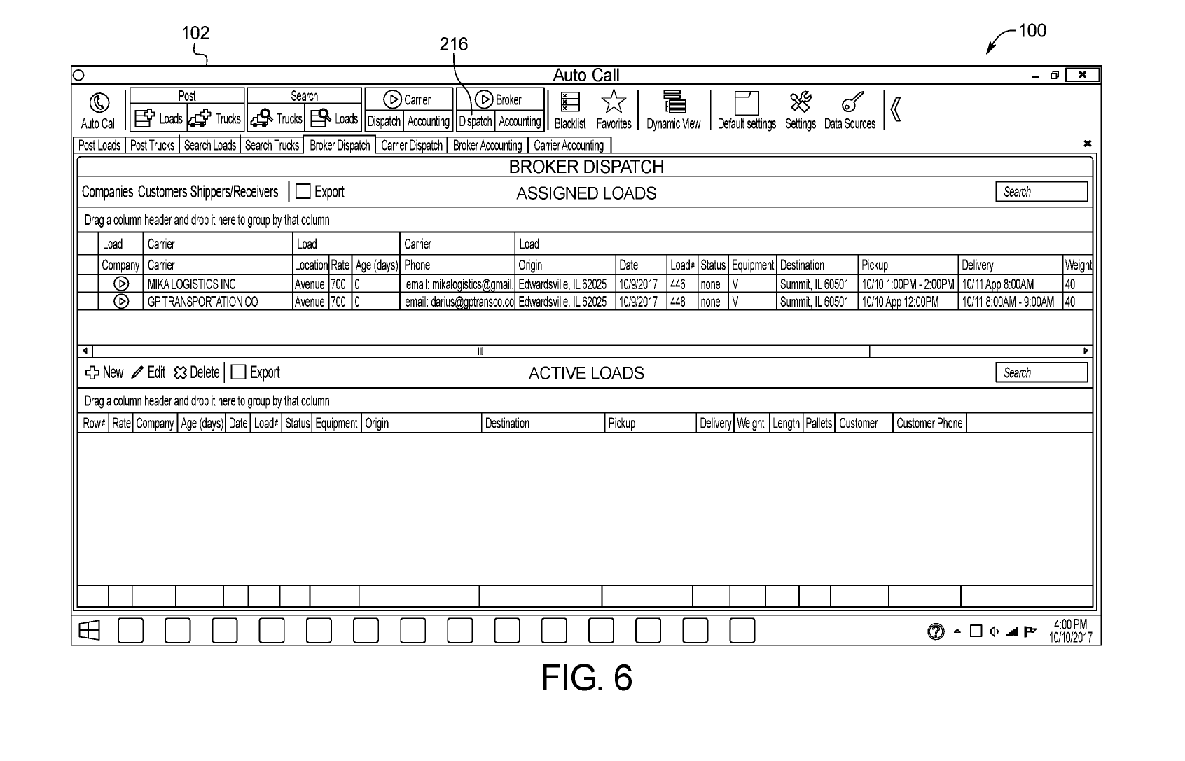

On the Broker Dispatch tab 216 on the main page shown in FIG. 6, a broker can track the load assignments for each of its carriers. The Broker Dispatch tab 216 lists the location, rate, and age of each load, the contact information for the carrier, the origin and destination, the date, the load number, the status, and the pick-up date and the delivery date for each carrier. The list of carriers may be separated into assigned loads that have yet to be transported and active loads that are currently being transported.

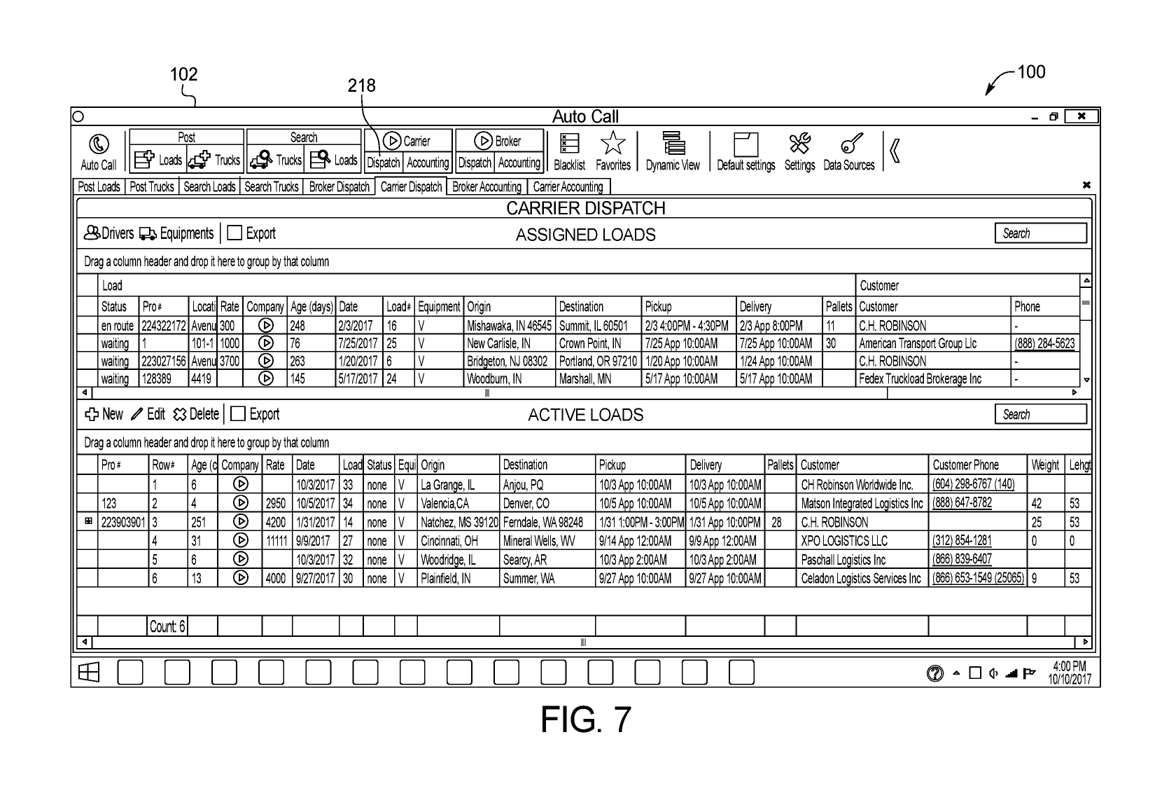

Similarly, the Carrier Dispatch tab 218 on the main page as shown in FIG. 7 provides the assigned and active loads for a carrier. The Carrier Dispatch tab lists the status, the location, the rate, the age, the date, the load number, equipment, origin and destination, pick-up and delivery date/time, number of pallets, the shipper, and the shipper phone for each load.

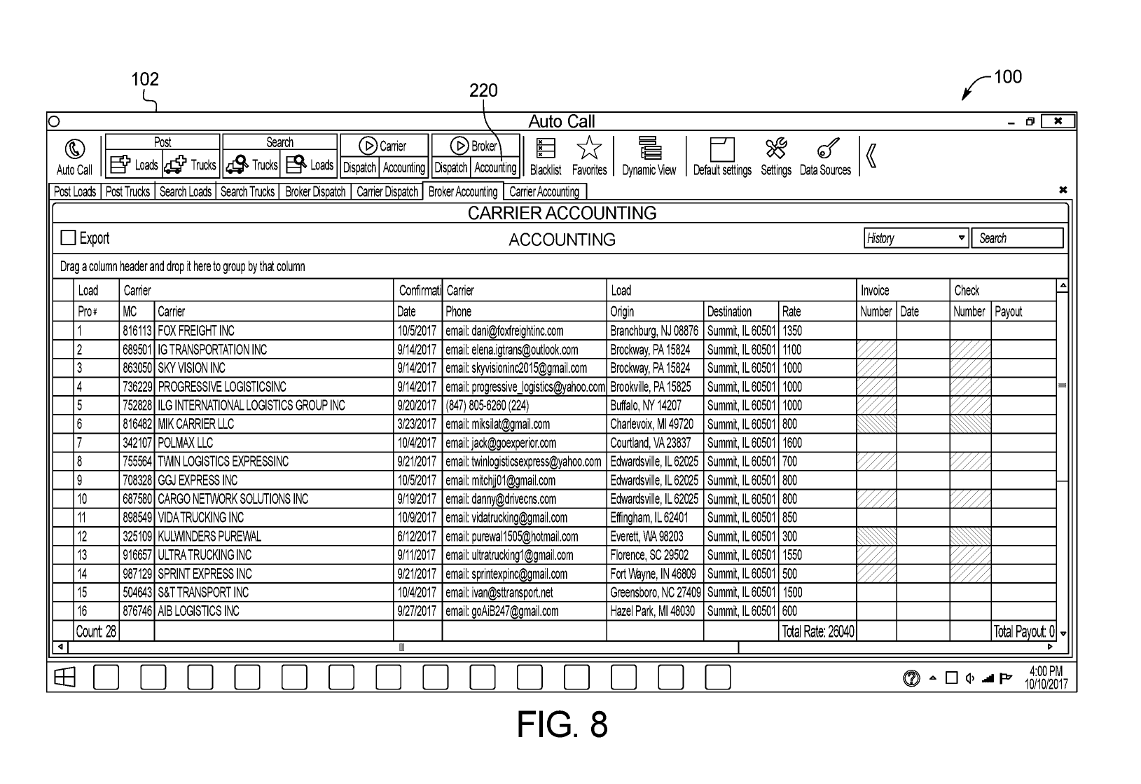

The Broker Accounting tab 220 on the main page lists accounting details for each load from the shipper's perspective, as shown in FIG. 8. The details may include the carrier name and contact information, the motor carrier number, the date of the delivery, the load origin and destination, the rate, the invoice number and date, and the check number and payout date.

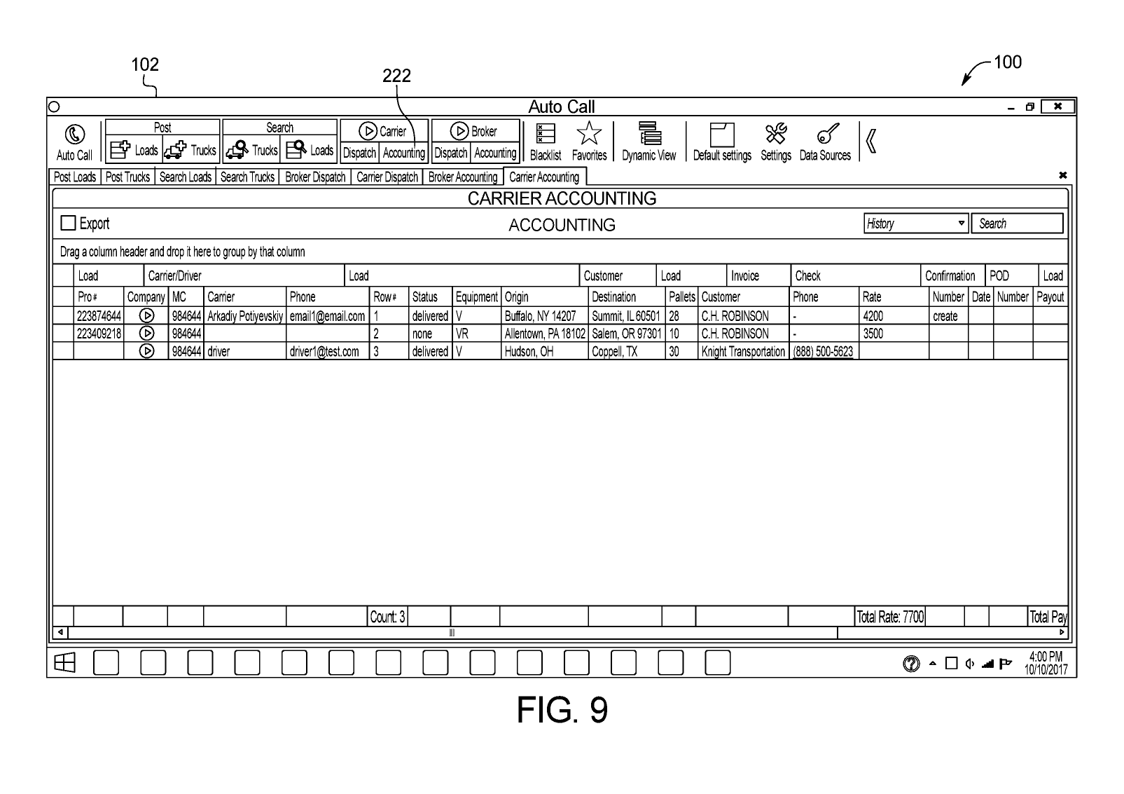

The Carrier Accounting tab 222 on the main page as shown in FIG. 9 provides the accounting details for each load from the carrier's perspective. The details may include the carrier name and contact information, the motor carrier number, the status and date of the delivery, the load origin and destination, the shipper, the rate, the invoice number and date, and the check number and payout date.

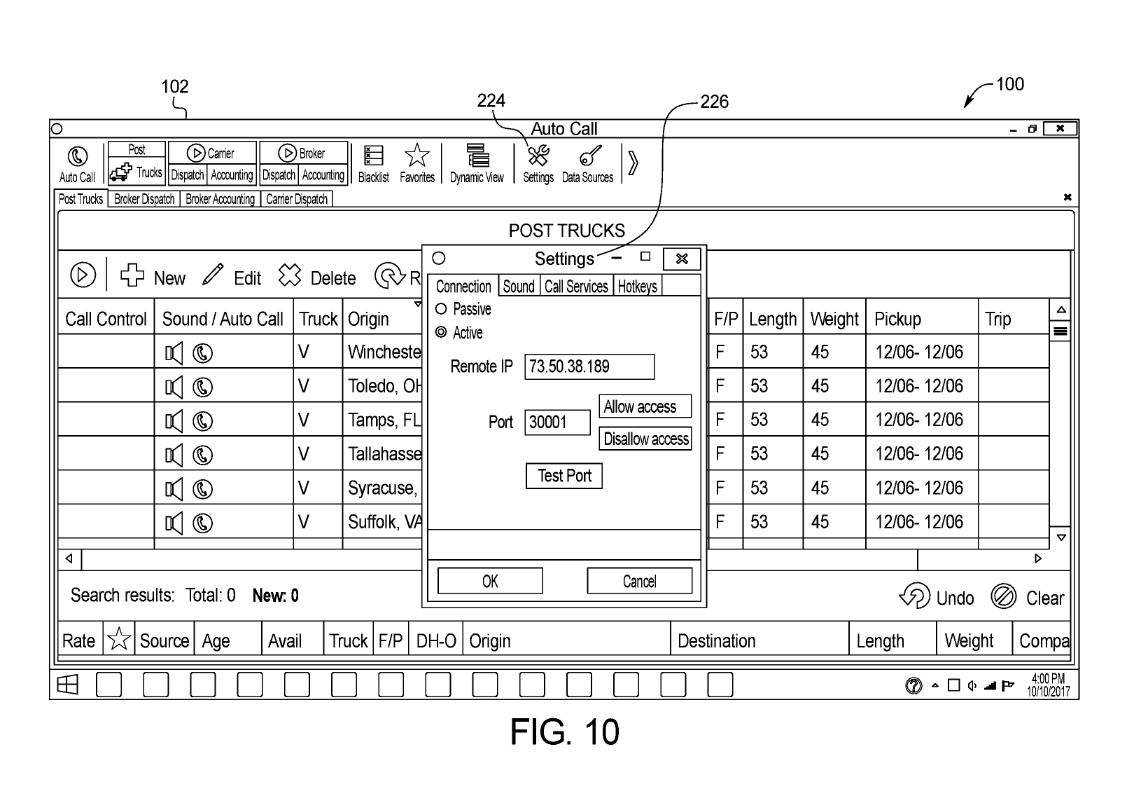

Referring to FIG. 10, the plurality of buttons in the header of the main page also includes buttons to modify the settings of the system. The user may select the Settings button 224 in the plurality of buttons, which leads to the Settings box 226. The Settings box includes settings for Connection, Sound, Call Services, and Hotkeys. In the Connection tab, the user may select whether the connection is active or passive, identify an IP address, and allow, disallow, and test a port. In the Sound tab, the user may select which sound file to use throughout the system. In the Call Services tab, the user may select the phone system such as Skype or Bria installed on the respective device that the freight logistics system will use to automatically call the contact information of the search results. The user may also select up to five phone lines to be used at a given time. In the Hotkeys tab, the user may select a keyboard shortcut to hang up the phone.

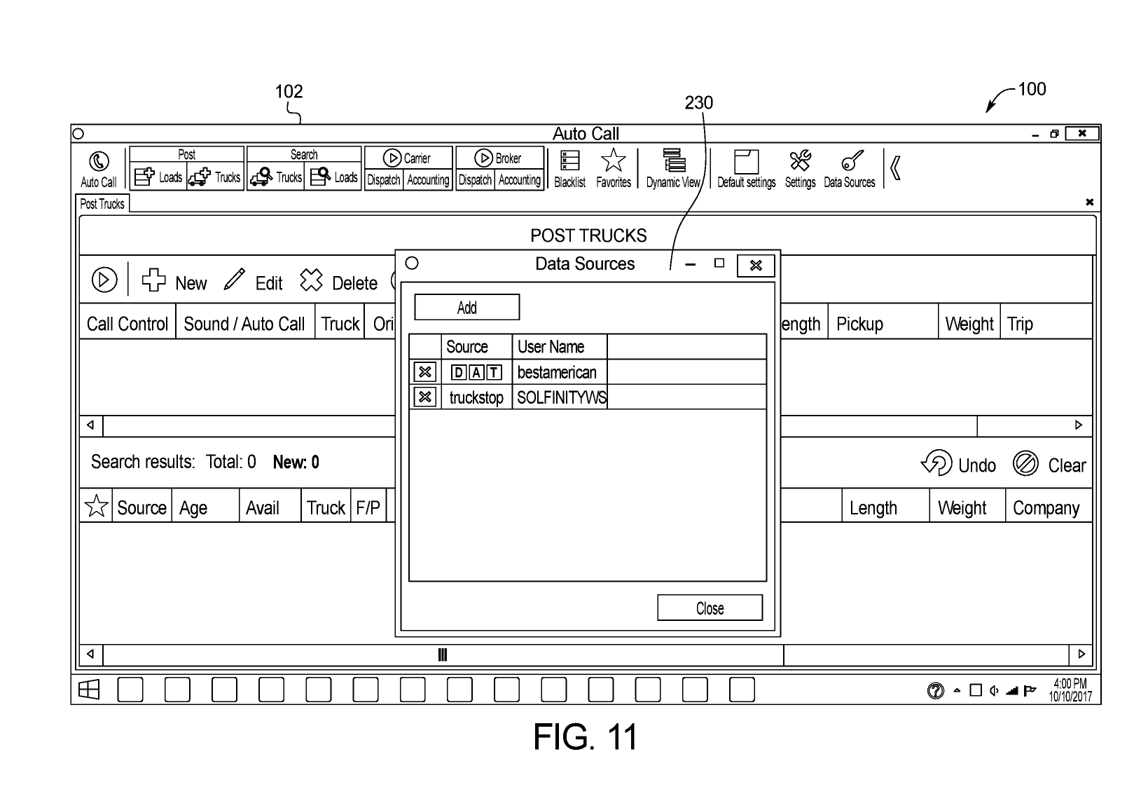

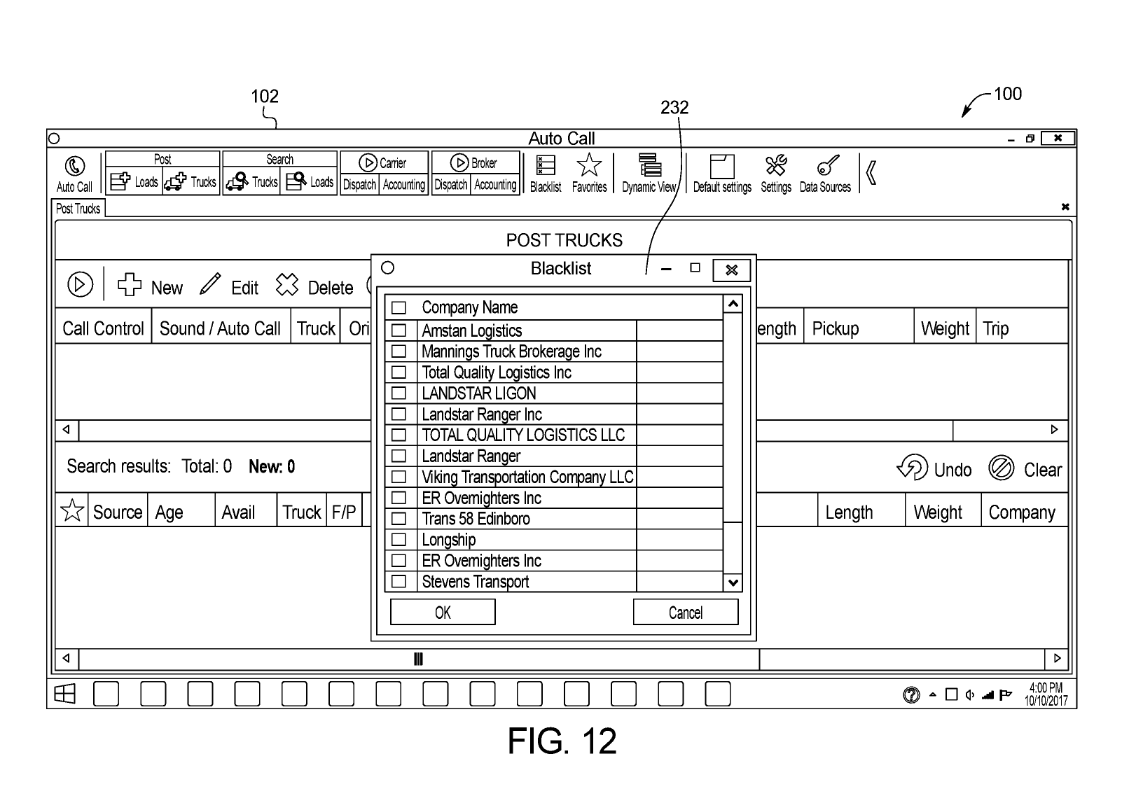

Selection of the Data Sources button in the header leads to the Data Sources settings box 230 shown in FIG. 11. Each of the freight exchange load boards may be selected or unselected in the Data Sources settings box. By selecting the Favorites button in the header, the user can select a preferred carrier, shipper, or freight broker in the Favorites settings box shown in FIG. 20. If the user wants to restrict one or more carriers, shippers, or freight brokers from the search results, the user can select the carrier, shipper, or freight broker to bar on the Blacklist settings box 232 shown in FIG. 12.

It should be understood that the lines of communication between the carriers, shippers, and brokers may be wired (copper, fiber, etc,) or wireless (microwave, radio frequency, satellite., infrared, etc.), and may utilize any form of data communication pursuant to any network or communication protocol now known or to be developed.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A system comprising:
a controller;
a memory coupled to the controller, wherein the memory is configured to store program instructions executable by the controller;
wherein in response to executing the program instructions, the controller is configured to:
receive a load data for shipment from a shipper, wherein the load data includes an amount of load, and a date for delivery;
receive locomotive availability information associated with a carrier, wherein the locomotive availability information includes carrier contact information, dates of availability, and a space amount of availability, wherein the locomotive availability information is stored in a database in communication with the controller;
select carriers from the database based on matching the load data for shipment with the received locomotive availability information associated with a carrier;
generating a likelihood of success for shipment of the load data by the date of delivery for each of the selected carriers;
identifying the carrier contact information associated with each carrier associated with a likelihood of success greater than a predefined success value;
contacting the identified carrier contact information;
receiving confirmation to ship the freight data by the requested delivery date from at least one contacted carrier; and
displaying the confirmed carrier information to a user interface associated with the shipper associated with the load data.

2. The system of claim 1, wherein the shipper is a publicly available freight exchange.

3. The system of claim 1, wherein contacting the locomotive contact information includes contacting the locomotive contact information associated with each carrier associated with a likelihood of success greater than a predefined success value from a user device associated with the shipper.

4. The system of claim 1, wherein contacting the locomotive contact information includes simultaneously calling up to five of the identified carrier contact information.

5. The system of claim 4, wherein once a call is accepted from an identified locomotive contact information, the remaining simultaneous calls are placed on hold.

6. The system of claim 5, wherein when the call ends, a new call is established automatically with a first identified carrier contact information on hold.

7. The system of claim 1, wherein the controller is configured to automatically contact the carrier contact information associated with each carrier associated with a likelihood of success greater than a predefined success value.

8. The system of claim 1, wherein the controller is further configured to
receive a carrier search request including at least one of a pick-up date, a delivery date, a pick-up location, a destination location, a truck type, and a load weight;
select a matching load request from the database, wherein the matching load request is compatible with the received search request; and
display the matching load request on a user interface associated with the carrier associated with the carrier search request.

9. The system of claim 8, wherein the controller is configured to automatically contact the shipper associated with the matching load request.

10. The system of claim 8, wherein the controller is configured to display on a user interface associated with the carrier contacting information associated with the shipper associated with the matching load request.

11. The system of claim 8, wherein the controller is configured to automatically contact the shipper associated with the matching load request, wherein the controller is configured to display carrier information associated with the matching load request, wherein the carrier information includes at least one of a carrier contact information, the pick-up date, the delivery date, the pick-up location, the destination location, the truck type, and the load weight.
